(19) United States
(12) Patent Application Publication
(10) Pub. No.: US 2013/0140315 A1
(43) Pub. Date: Jun. 6, 2013

(54) Drinking Container for Use of Consumable Beverage and Method Thereof

(71) Applicant: Zhenming Ni, Shanghai (CN)

(72) Inventor: Zhenming Ni, Shanghai (CN)

(73) Assignee: Shanghai Yuhao Household Appliance Manufacturing Co., Ltd, Shanghai (CN)

(21) Appl. No.: 13/427,936

(22) Filed: Mar. 23, 2012

Related U.S. Application Data
(60) Provisional application No. 61/630,016, filed on Dec. 2, 2011.

(51) Int. Cl. A47G 19/22; B23P 11/00

(52) U.S. Cl. 220/592.17; 220/529; 220/371; 222/1; 29/428

(57) ABSTRACT

A drinking container comprises a retaining member detachably coupled with a container body at a mouth thereof, and a media storing member detachably mounted with the retaining member for processing the beverage, wherein the beverage is thermal treated by the media storing in the media storing member and filtrated by the retaining member installed with a filtration media.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a drinking container for use of consumable beverage and method thereof, and more particularly to a drinking container for processing consumable beverage housed therein and method thereof, wherein the consumable beverage is capable of being thermal treated and filtrated before accessable to a user.

2. Description of Related Arts

A conventional portable beverage bottle typically includes a container for storing beverage and a removable lid for sealing off the container. But the beverage stored in the conventional bottle may not provide an additional flavor taste, for example, people prefer to enjoy the chilly taste of the beverage but the conventional bottle often fails to keep the beverage at a relatively low temperature. We may also prefer to add into pure water with tea, fruit juice, or other ingredients to adjust the flavor. Furthermore, beverage such as drinking water may still need a filtration process to remove impurity and increase its integrity. Therefore, we need a drinking container for processing the beverage before the beverage is accessible to a user.

### SUMMARY OF THE PRESENT INVENTION

A main object of the present invention is to provide a drinking container and a method for processing consumable beverage housed in the drinking container, wherein the beverage is thermal treated, flavor adjusted, or filtrated before the beverage is accessible to a user.

Another object of the present invention is to provide a drinking container, wherein the drinking container comprises a media storing member and a retaining member detachably coupled with the media storing member, wherein the retaining member detachably mount the media storing member with a container body which is used for storing beverage, wherein when the media stored in the media storing member is thermal treatment solvent, the beverage can be cooled or heated, and when the media is tea, fruit juice or other ingredients, the beverage can be added with additional flavor.

Another object of the present invention is to provide a drinking container, wherein the media storing member comprises a main body having a storing chamber, wherein thermal treatment solvent is received in the storing chamber, wherein the media storing member undergo a cooling process before installing to the container body so that the beverage in the container body is maintained at a relatively low temperature, so that a chilly consumable beverage is obtained.

Another object of the present invention is to provide a drinking container, wherein the retaining member comprises a body portion having an opening, wherein the media storing member, which is elongated in shape, penetrate through the opening and is detachably mounted with the retaining member, wherein the retaining member can be detachably seated on the mouth of the container body, so that both the retaining member and the media storing member can be easily detached from the container body and it is also easy to clean the drinking container.

Another object of the present invention is to provide a drinking container, wherein the body portion of the retaining member has a plurality of holes for beverage to pass through, wherein the body portion further has a receiving cavity receiving a filtration media, so that when the retaining member is mounted to the container body at the mouth, the beverage getting out of the container body from the mouth undergoes a filtration process, so that the integrity of the beverage is increased.

Another object of the present invention is to provide a drinking container, wherein the body portion of the retaining member comprises a first half casing and a second half casing defining the receiving cavity, wherein the first half casing extends substantially orthogonally about an axis of the opening and defines the receiving cavity which is also provided substantially orthogonally about the axis of the opening, wherein the second half casing is a sealing member detachably disposed in the receiving cavity, wherein the filtration media is received in the receiving cavity between the first half casing and the second half casing, so that the filtration media is easy to be replaced for a new one and the retaining member is also easy to be cleaned.

Another object of the present invention is to provide a drinking container, wherein the drinking container comprises a filtrating member, wherein the filtrating member comprises a body portion having a receiving cavity, wherein a filtration media is received in the receiving cavity, wherein the filtrating member is detachably mounted to the container body at the mouth thereof, so that the beverage received in the container body undergoes a filtration process at the filtrating member.

Another object of the present invention is to provide a drinking container, wherein the filtrating member has an opening and the drinking container further comprises a media storing member passing through the opening and detachably mounted with the filtrating member, wherein the media storing member is loaded with thermal treatment solvent, so that the beverage received in the contained can be cooled or heated by the media storing member, so that a chilly or warm beverage is obtained.

Another object of the present invention is to provide a drinking container, wherein the structure of the drinking container is not complicated and also is inexpensive and affordable for all users.

Additional advantages and features of the invention will become apparent from the description which follows, and may be realized by means of the instrumentalities and combinations particular point out in the appended claims.

According to the present invention, the foregoing and other objects and advantages are attained by a drinking container comprising: a container body defining a receiving chamber having a mouth, wherein beverage is received in the receiving chamber, a retaining member detachably coupled with said container body at said mouth; and a media storing member detachably mounted with said retaining member for processing said beverage.

In accordance with another aspect of the invention, the present invention comprises a method for processing beverage housed in a container body having a mouth, wherein the method comprises the following steps.

(a) Provide a retaining member at the mouth in such a manner that the retaining member is detachably coupled with the container body, wherein the retaining member has an opening.

(b) Retain a media storing member in the container body at the mouth by the retaining member in such a manner that the media storing member pass through the opening to have contact with the beverage stored in the container body.

The method selectively comprises a step (c): Guide the beverage to pass through a plurality of holes of the retaining member which is installed with a filtrating member in such a manner that the beverage is filtrated by the filtration media.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a drinking container according to a preferred embodiment of the present invention.

FIG. 2 is a schematic view illustrating the retaining member and the media storing member being coupled with the container body at the mouth thereof according to the above preferred embodiment of the present invention.

FIG. 3 is a schematic view illustrating the retaining member and the media storing member being detached from the container body according to the above preferred embodiment of the present invention.

FIG. 4 is a schematic view of the retaining member and the media storing member of the drinking container according to the above preferred embodiment of the present invention.

FIG. 5 is a schematic view illustrating the media storing member being capable of sliding along the elongated retaining member to be detached from the retaining member according to the above preferred embodiment of the present invention.

FIG. 6 is a perspective view of the retaining member of the drinking container according to the above preferred embodiment of the present invention.

FIG. 7 is a bottom view of the retaining member of the drinking container according to the above preferred embodiment of the present invention.

FIG. 8 is a sectional view of the retaining member of the drinking container according to the above preferred embodiment of the present invention.

FIG. 9 is an exploded view of the retaining member of the drinking container according to the above preferred embodiment of the present invention.

FIG. 10 is a top view of the media storing member of the drinking container according to the above preferred embodiment of the present invention.

FIG. 11 is a sectional view of the media storing member of the drinking container according to the above preferred embodiment of the present invention.

FIG. 12 is a top view illustrating the media storing member engaging with the retaining member according to the above preferred embodiment of the present invention.

FIG. 13 is a top view of the mouth of the container body according to the above preferred embodiment of the present invention.

FIG. 14 is a top view of the lid of the container body according to the above preferred embodiment of the present invention.

FIG. 15 is a schematic view illustrating the pull top of the lid of the container body according to the above preferred embodiment of the present invention, wherein the pull top is in a state in which the pull top seals off the lid.

FIG. 16 is a schematic view illustrating the pull top of the lid of the container body according to the above preferred embodiment of the present invention, wherein the pull top is in an another state in which the pull top is pulled out to discharge beverage.

### DETAILED DESCRIPTION OF THE PREFERRED EMBODIMENT

The following description is disclosed to enable any person skilled in the art to make and use the present invention. Preferable embodiments are provided in the following description only as examples and modifications will be apparent to those skilled in the art. The general principles defined in the following description would be applied to other embodiments, alternatives, modifications, equivalents, and applications without departing from the spirit and scope of the present invention.

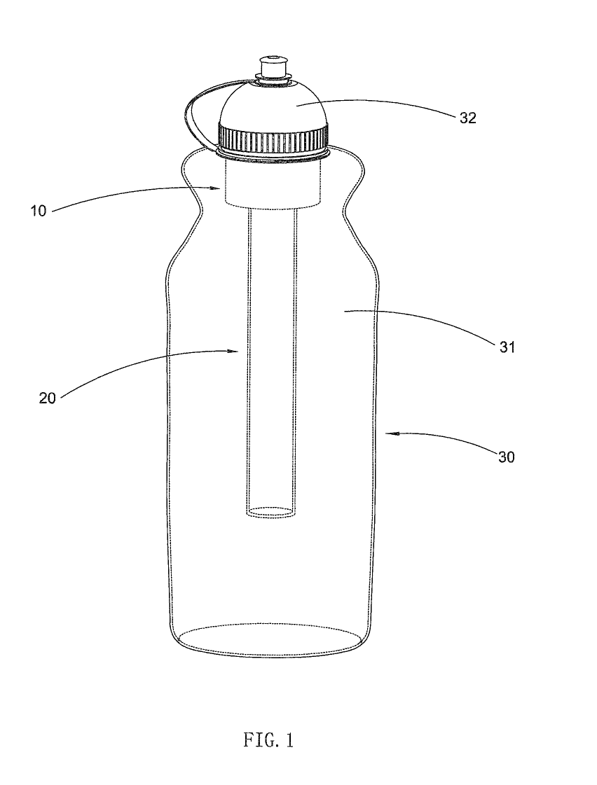

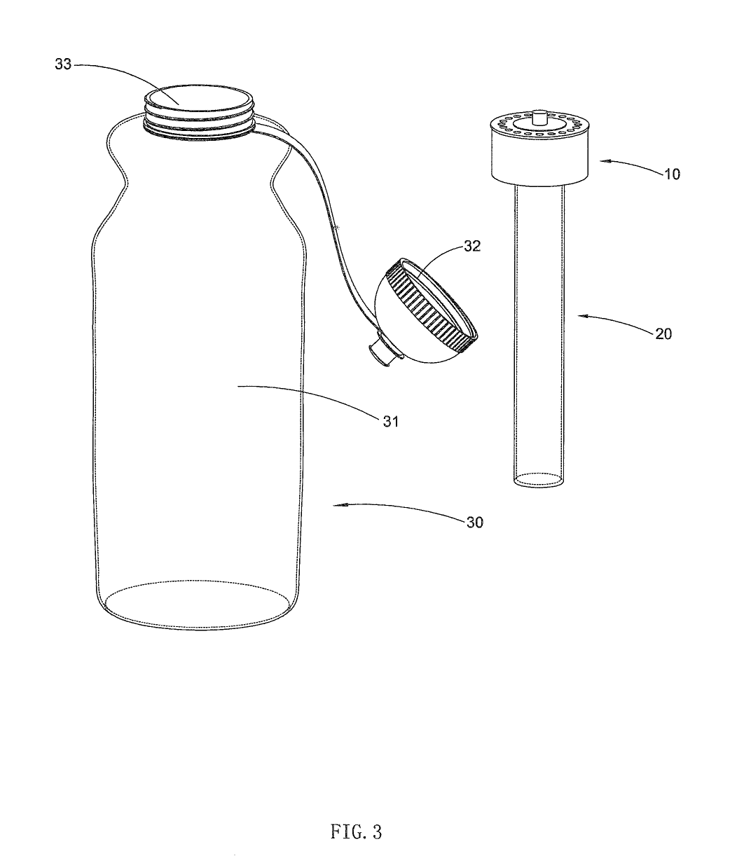

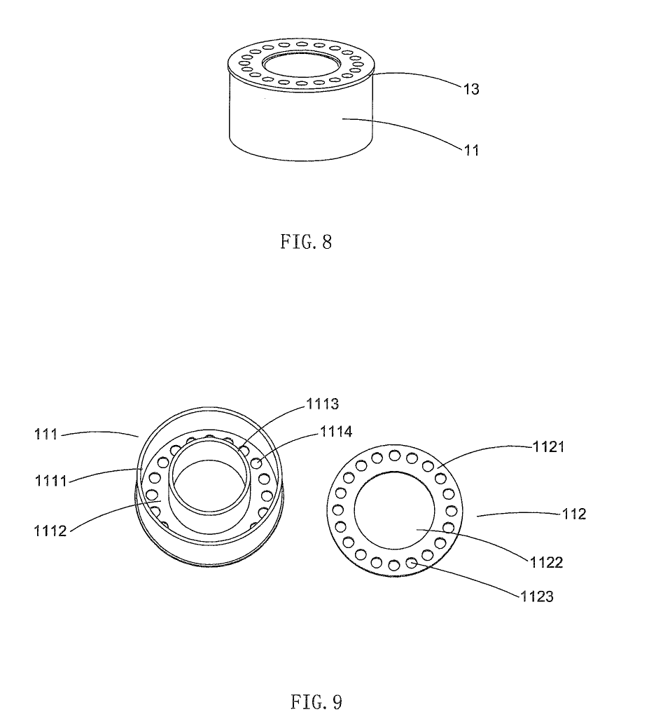

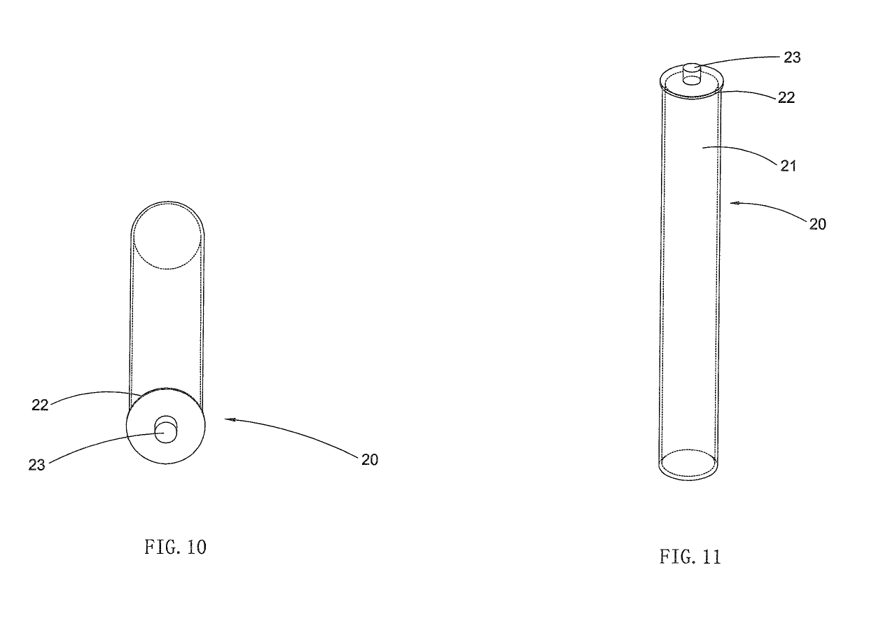

Referring to FIG. 1 to FIG. 16 of the drawings, a drinking container for processing beverage housed therein is illustrated, wherein the drinking container comprises a retaining member 10, a media storing member 20, and a container body 30. The retaining member 10 is detachably coupled with the container body 30, and the media storing member 20 is detachably mounted with the retaining member 10 for processing the beverage.

The media storing member 20 comprises a main body 21 having a storing chamber, wherein a media contained in the storing chamber of the media storing member 20 can be thermal treatment solvent or other flavor adjusting ingredients such as tea, fruit juice, coffee power, and the like. According to this preferred embodiment, the media is thermal treatment solvent, especially, the thermal treatment solvent is used for maintaining the beverage at a relatively low temperature, so that a user can enjoy the chilly taste of the beverage. Accordingly, the thermal treatment solvent preferably contains a gelatinous material that is formed of re-freezable material and/or re-heatable material, such as non-toxic material used in gel packs and the like.

Accordingly, the media storing member 20 with thermal treatment solvent can be pre-cooled in a cooling machine such as a refrigerator, and then the media storing member 20 is installed to the container body 30, so that the beverage in the container body 30 is thermal exchanging with the thermal treatment solvent and maintain at a relatively low temperature. Accordingly, the beverage stored in the container body 30 can be any drinks, such as wine, water, and the like. As an example, the container body 30 is a portable bottle for storing drinking water.

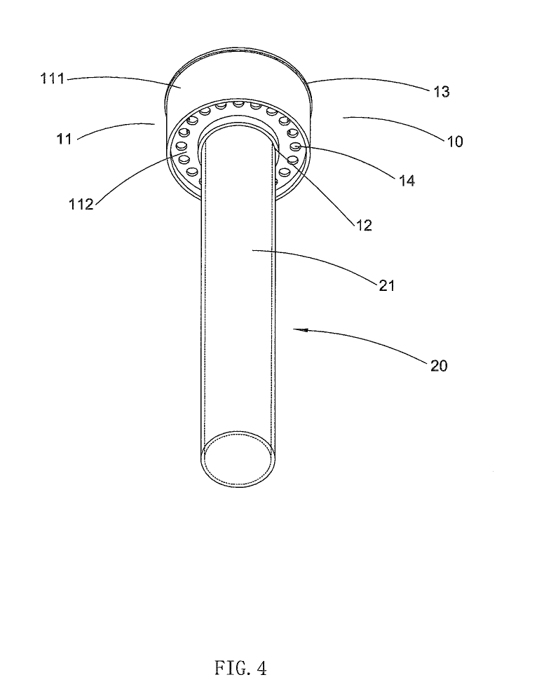

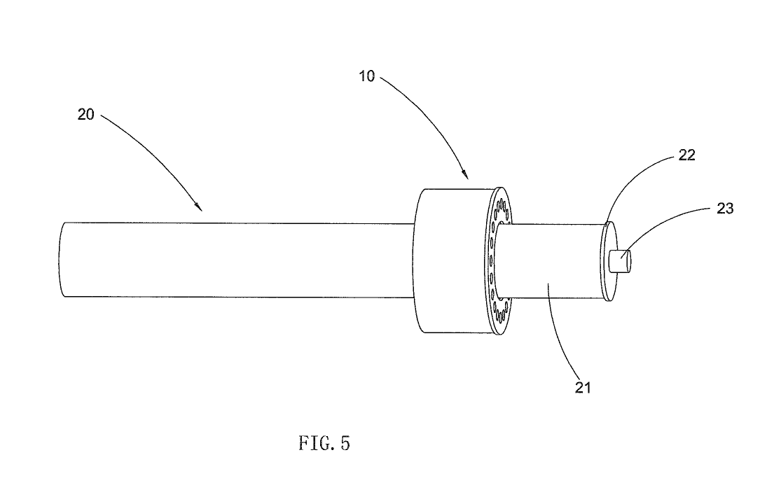

Accordingly, the media storing member 20 is detachably mounted to the retaining member 10. More specifically, the main body 21 of the media storing member 20 is constructed to be elongated in shape, the retaining member 10 comprises a body portion 11 defining an opening 12, wherein the main body 21 of the media storing member 20 is capable of sliding in the opening 12 of the retaining member 10 in such a manner that the media storing member 20 is detachably coupled with the retaining member 10, as shown in FIG. 4 and FIG. 5.

The main body 21 of the media storing member 20 can be any shape, size, or figure. As an example, the main body 21 of the media storing member 20 is a cylinder. It is noteworthy that the media storing member 20 further comprises a thread portion 22 outwardly extended from an outer surface of an end of the main body 21. Correspondingly, the body portion 11 of the retaining member 10 has an indent 15 inwardly formed along an inner surface of a proximate end thereof. In other words, the inner surface of the proximate end of the body portion of the retaining member 10 forms a shoulder portion in such a manner that when the main body 21 of the media storing member 20 is put into the opening 12 of the retaining member 10, the thread portion 22 of the media storing member 20 is received in the indent 15 of retaining member 10.

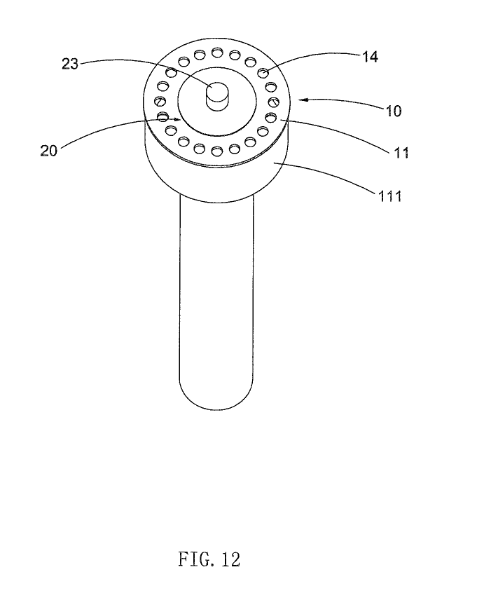

In other words, the thread portion 22 of the media storing member 20 is seated on the shoulder portion formed by the indent 15 so that the media storing member 20 is retained on the retaining member 10 at the proximate end thereof, as shown in FIG. 4 and FIG. 12. Accordingly, when a force is applied on the retaining member 10 on the proximate end thereof, the retaining member 10 slides along the elongated main body 21 of the media storing member 20 and can be detached from the media storing member 20 from another end of the media storing member 20. In other words, the media storing member 20 is capable of sliding out of the opening 12 of the retaining member 10 in such a manner that the media storing member 20 is detached from the retaining member 10. Accordingly, the detachably engagement manner enables easy cleaning of the drinking container and replacement of the retaining member 10 or the media storing member 20 for a new one.

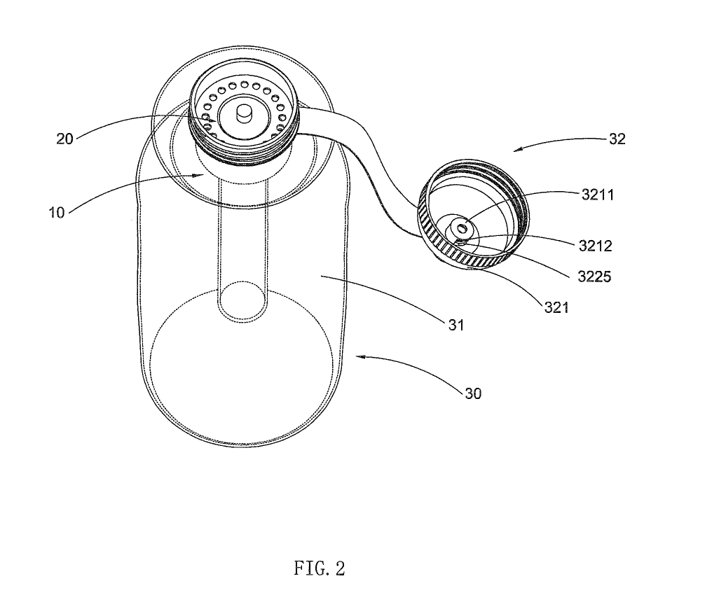

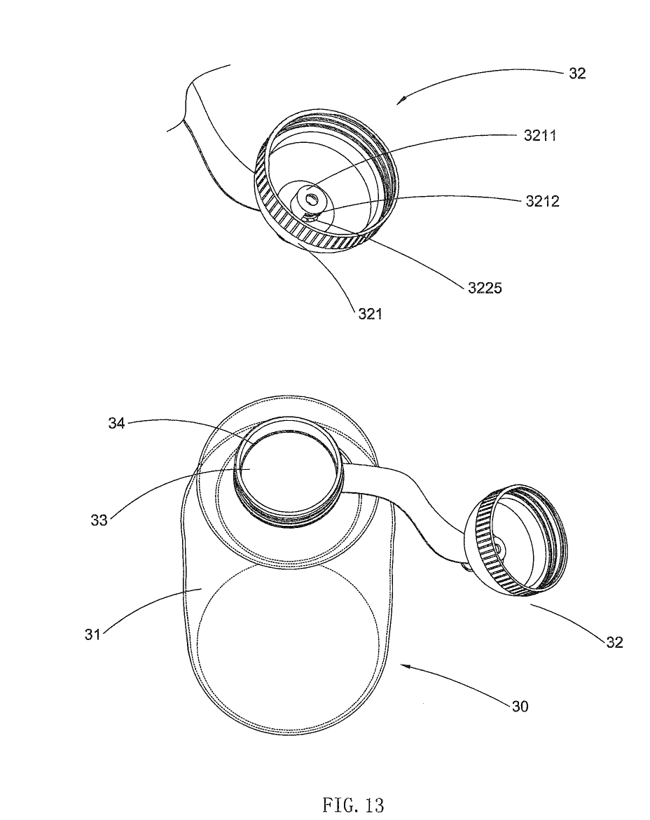

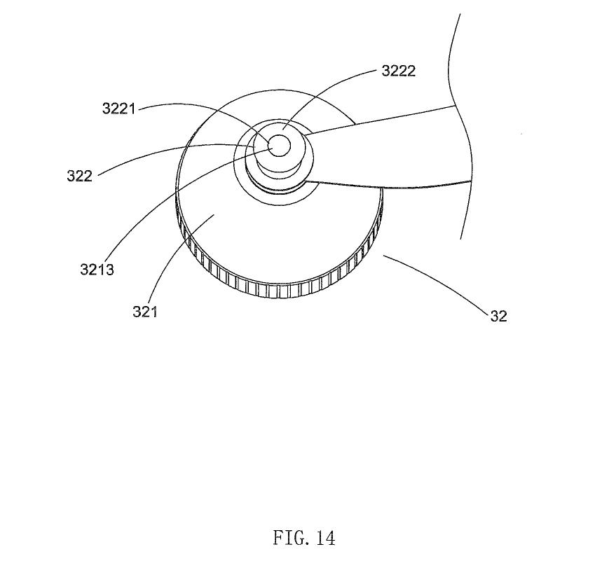

Accordingly, the container body 30 can be any shape, size and figure. According to this preferred embodiment, the container body 30 defines a receiving chamber 31 having a mouth 33 and a removable lid 32 closing off the mouth 33. The retaining member 10 is capable of being detachably coupled with the container body 30, the detachable engagement can be configured in various manners, according to this preferred embodiment, the container body 30 comprises a thread support 34 at the mouth 33, as shown in FIG. 13. The retaining member 10 comprises a seat portion 13 outwardly extended from an outer surface of the proximate end thereof, wherein when the retaining member 10 is put into the container body 30 at the mouth 33, the seat portion 13 of the retaining member 10 is seated on the thread support 34 of the container body 30, as shown in FIG. 2.

When the media storing member 20 is mounted to the retaining member 10, the retaining member 10 is capable of detachably mounting the media storing member 20 with the container body 30. Therefore, the media storing member 20 is installed into the container body 30, and when the media storing member 20 is loaded with thermal treatment solvent, the beverage stored in the container body is heat-exchanging with thermal treatment solvent and maintained at a desired temperature. For example, the beverage is kept in a chilly state when the media storing member is pre-cooled in a refrigerator.

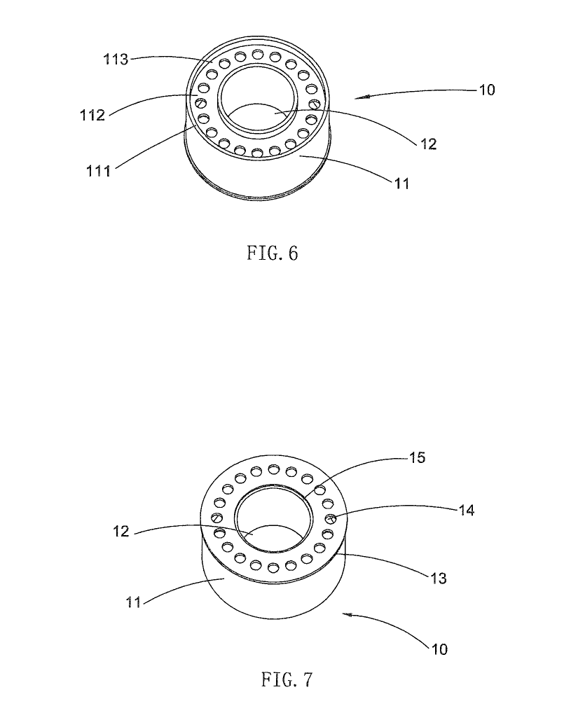

Referring to FIG. 6 to FIG. 9 of the drawings, the detailed structure of the retaining member 10 is illustrated, wherein the body portion 11 of the retaining member 10 has a plurality of holes 14 for beverage to pass through, wherein the body portion 11 further has a receiving cavity 113 receiving a filtration media, so that when the retaining member 10 is mounted to the container body 30 at the mouth 33, the beverage getting out of the container body 30 from the mouth 33 undergoes a filtration process, so that the integrity of the beverage is increased. In other words, the retaining member 10 can be a filter, so that the drinking container not only provides a thermal treatment process by the media storing member 20, but also a filtration process by the retaining member 10.

More specifically, the body portion 11 of the retaining member 10 comprises a first half casing 111 and a second half casing 112 defining the receiving cavity 113, wherein the first half casing 111 extends substantially orthogonally about an axis of the opening 12 and defines the receiving cavity 113 which is also provided substantially orthogonally about the axis of the opening 12. The second half casing 112 is a sealing member detachably disposed in the receiving cavity 113 to close off the receiving cavity 113, wherein the filtration media is received in receiving cavity 113 between the first half casing 111 and the second half casing 112, so that the filtration media is easy to be replaced for a new one and the retaining member 10 is also easy to be cleaned.

Referring to FIG. 9 of the drawing, the first half casing 111 comprises a bottom panel 1112 extended substantially orthogonally about an axis to define the opening 12, and an outer wall 1111 and an inner wall 1113 coaxially extended from an outer edge and an inner edge of the bottom panel 1112 respectively. The space between the outer wall 1111 and the inner wall 1113 forms the receiving cavity 113 for the filtration media to be disposed therein. The second half casing 112 with an opening 12 is a sealing member disposed between the inner wall 1113 and the outer wall 1111 for closing off the receiving cavity 113. Accordingly, bottom panel 1112 of the first half casing 111 and the second half casing 112 are both provided with communication holes for beverage to pass therethrough. Accordingly, the seat portion 13 is provided at the proximate end of the retaining member 10, and the second half casing 112 closes off the receiving cavity at a distal end of the retaining member 10.

Preferably, the second half casing 113 is an annular loop and the bottom panel 1112 is another loop so that the integral retaining member 10 forms a cylinder which is suitable for disposing in the mouth 33 which is constructed in circular shape.

It is worth to mention that the retaining member can be made of any suitable material such as polyethylene terephthalate, polyvinyl chloride, high density polyethylene and the like.

When the retaining member 10 is disposed in the mouth 33 of the container body 30, the beverage getting out of the container body 30 through the mouth 33 will be filtrated by the filtration media provided in the retaining member 10. Accordingly, the filtration media can be carbon, active carbon, charcoal, reverse osmosis, distiller, backwash or other suitable filtration media.

It is worth to mention that the container body 30 can be any suitable bottle, and can be made of any suitable material such as polyethylene terephthalate, polyvinyl chloride, high density polyethylene, low density polyethylene, thermoplastic polymer, polypropylene, oriented polypropylene, polyurethane, polyester, metal, synthetic rubber, natural rubber, silicone, nylon, polymer and the like.

The container body 30 can be constructed with various kinds of structure. According to this preferred embodiment, the container body 30 is a portable bottle. The removal lid 32 comprises a lid body 321 and a pull top 322. The lid body 321 has a retainer 3211 defining a passage 3212 between the lid body 321 and the pull top 322 for beverage to pass therethrough, Accordingly, the media storing member 20 further comprises a protrusion portion 23 extended from the end thereof at the thread portion 22, the retainer 3211 has a first end protrudely extended from an inner surface of the lid body 321, so that when the media storing member 20 is retained in the container body 30 by the retaining member 10 while the lid 32 is fastened at the mouth 33 of the container body, the first end of the retainer 3211 is biased against the protrusion portion 23 to retain the media storing member 20 in position. It is worth to mention that the retainer 3211 is an elongated tube defining a channel, wherein the protrusion portion 23 is received in the channel so that the media storing member 20 is retained in position.

Referring to FIG. 14 to FIG. 16 of the drawings, the pull top 322 comprises a pull head 3222 having an outlet 3221 for beverage to get out of the lid 32, wherein the retainer 3211 has a second end sealing off the outlet 3221. Accordingly, the pull top 32 further comprises an elongated retaining arm 3223 pivotally extended from the head 3222, a thread 3224 wound around the retaining arm 3223, and a hook 3225 open or close the passage 3212.

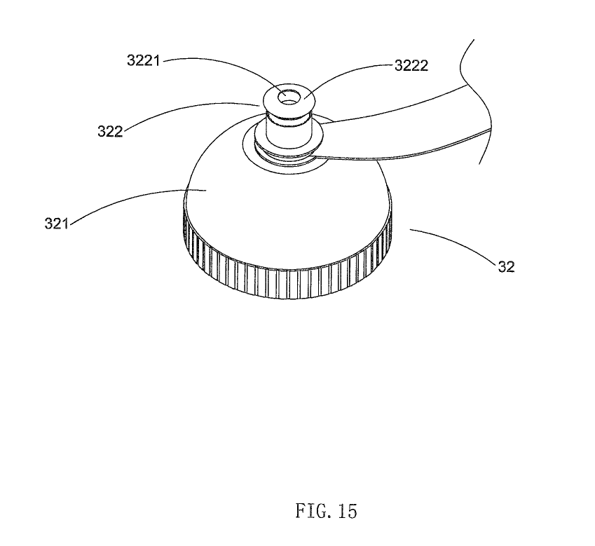

Referring to FIG. 15 of the drawing, when the pull top 322 is in a state in which the pull top 322 seal off the lid 321, the hook 3225 is sealedly engaged with the first end of the retainer 3211 so that the passage 3212 is closed, wherein the thread 3224 is retained in a slot along an inner surface of the lid head (not shown in the drawing), and the second end of the retainer 3211 seals off the outlet 3221 of the pull top 322 so that the beverage cannot get out from the outlet 3221.

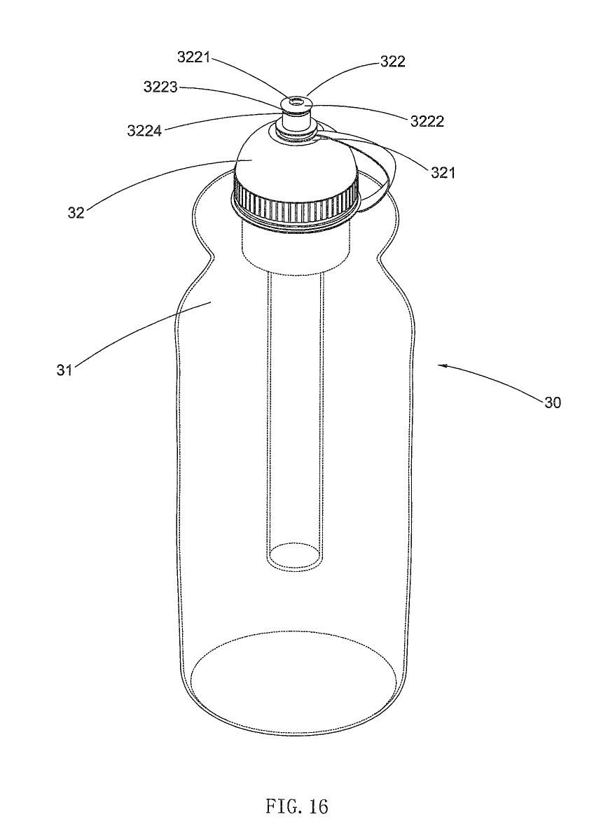

Referring to FIG. 16 of the drawing, when the pull top 322 is pulled out from the lid head, the hook 3225 is biasing against an inner surface of the lid 321 to open the passage 3212, wherein a gap is formed between the second end of the retainer 3211 and the pull head 3222, so that beverage gets out of the outlet 3221 from the space between the retainer 3211 and the pull top 322.

Accordingly, the present invention provides a method for processing beverage housed in a container body 30 having a mouth 33, wherein the method comprises the following steps.

(a) Provide a retaining member 10 at the mouth 33 in such a manner that the retaining member 10 is detachably coupled with the container body 30, wherein the retaining member 10 has an opening 12.

(b) Retain a media storing member 20 in the container body 30 at the mouth 33 by the retaining member 10 in such a manner that the media storing member 20 passes through the opening 12 to have contact with the beverage stored in the container body.

The method may further comprises a step (c): Guide the beverage to pass through a plurality of holes 14 of the retaining member which is installed with a filtrating member in such a manner that the beverage is filtrated by the filtration media.

The step (a) comprises the following steps.

(a.1) Provide a first half casing 111 defining a receiving cavity 113, wherein the first half casing 111 extends substantially orthogonally about an axis of the opening 12 and defines a receiving cavity 113 which is also provided substantially orthogonally about the axis of the opening 12.

(a.2) Provide a second half casing 112 detachably disposed in the receiving cavity 113 to close off the receiving cavity 113, wherein the filtration media is received in the receiving cavity 113 between the first half casing 111 and the second half casing 112.

Preferably, the first half casing 111 in step (a.1) comprises a bottom panel 1112 extended substantially orthogonally about an axis to define the opening 12, and an outer wall 1111 and an inner wall 1113 coaxially extended from an outer edge and an inner edge of the bottom panel 1112 respectively. The space between the outer wall 1111 and the inner wall 1113 forms the receiving cavity 113 for the filtration media to be disposed therein.

The second half casing 112 in step (a.2) is a sealing member disposed between the inner wall 1113 and the outer wall 1111 for closing off the receiving cavity 113.

Preferably, in the step (b), the media storing member 20 is filled with thermal treatment solvent, so that the beverage is heat-exchanging with the thermal treatment solvent.

Furthermore, in the step (b), the body portion 11 of the retaining member 10 has an indent 15 inwardly formed along an inner surface of a proximate end thereof, when the main body 21 of the media storing member 20 is put into the opening 12 of the retaining member 10, the retaining member 10 retaining the media storing media in position in such a manner that the thread portion 22 of the media storing member 20 is received in the indent 15 of retaining member 10.

From another aspect of the present invention, the drinking container comprises a filtrating member 10 having a receiving cavity 113, wherein a filtration media is provided in the receiving cavity 113. The container body 30 defines a receiving chamber 31 has a mouth 33, wherein the filtrating member 10 is detachably mounted to the container body 30 at the mouth 33 in such a manner that the beverage in the container body 30 is filtrated by the filtration media when getting out of the container body 30 through the mouth 33.

Accordingly, the container body 30 comprises a thread support 34 at the mouth 33, as shown in FIG. 13. The filtrating member 10 comprises a seat portion 13 outwardly extended from an outer surface of the proximate end thereof, wherein when the filtrating member 10 is put into the container body 30 at the mouth 33, the seat portion 13 of the filtrating member 10 is seated on the thread support 34 of the container body 30, as shown in FIG. 2.

Furthermore, the drinking container comprises a media storing member 20 detachably coupled with the filtrating member 10 for processing the beverage. The media storing member 20 comprises a main body 21 having a storing chamber, wherein a media contained in the storing chamber of the media storing member 20 can be thermal treatment solvent or other flavor adjusting ingredients such as tea, fruit juice, coffee power, and the like.

The filtrating member 10 comprises a body portion 11 has an indent 15 inwardly formed along an inner surface of a proximate end thereof. In other words, the inner surface of the proximate end of the body portion of the filtrating member 10 forms a shoulder portion in such a manner that when the main body 21 of the media storing member 20 is put into the opening 12 of the filtrating member 10, the thread portion 22 of the media storing member 20 is received in the indent 15 of the filtrating member 10.

In other words, the thread portion 22 of the media storing member 20 is seated on the shoulder portion formed by the indent 15 so that the media storing member 20 is retained on the filtrating member 10 at the proximate end thereof, as shown in FIG. 4 and FIG. 12. Accordingly, when a force is applied on the filtrating member 10 on the proximate end thereof, the filtrating member 10 slides along the elongated main body 21 of the media storing member 20 and can be detached from the media storing member 20 from another end of the media storing member 20. In other words, the media storing member 20 is capable of sliding out of the opening 12 of the filtrating member 10 so that the media storing member 20 is detached from the filtrating member 10.

As the media storing member 20 is mounted to the filtrating member 10, the filtrating member 10 is capable of detachably mounting the media storing member 20 with the container body 30. Therefore, the media storing member 20 is installed into the container body, and when the media storing member 20 is loaded with thermal treatment solvent, the beverage stored in the container body is heat-exchanging with thermal treatment solvent and maintain at a desired temperature. For example, the beverage is kept in a chilly state when the media storing member is pre-cooled in a refrigerator.

Referring to FIG. 6 to FIG. 9 of the drawings, the detailed structure of the filtrating member 10 is illustrated, wherein the body portion 11 of the filtrating member 10 has a plurality of holes 14 for beverage to pass through, wherein the body portion 11 further has a receiving cavity 113 receiving a filtration media, so that when the filtrating member 10 is mounted to the container body 30 at the mouth 33, the beverage getting out of the container body 30 from the mouth 33 undergoes a filtration process, so that the integrity of the beverage is increased.

More specifically, the body portion 11 of the filtrating member 10 comprises a first half casing 111 and a second half casing 112 defining the receiving cavity 113, wherein the first half casing 111 extends substantially orthogonally about an axis of the opening 12 and defines the receiving cavity 113 which is also provided substantially orthogonally about the axis of the opening 12. The second half casing 112 is a sealing member detachably disposed in the receiving cavity 113 to close off the receiving cavity 113, wherein the filtration media is received in receiving cavity 113 between the first half casing 111 and the second half casing 112, so that the filtration media is easy to be replaced for a new one and the filtrating member 10 is also easy to be cleaned.

Referring to FIG. 9 of drawing, the first half casing 111 comprises a bottom panel 1112 extended substantially orthogonally about an axis to define the opening 12, and an outer wall 1111 and an inner wall 1113 coaxially extended from an outer edge and an inner edge of the bottom panel 1112 respectively. The space between the outer wall 1111 and the inner wall 1113 forms the receiving cavity 113 for the filtration media to be disposed therein. The second half casing 112 with an opening 12 is a sealing member disposed between the inner wall 1113 and the outer wall 1111 for closing off the receiving cavity 113. Accordingly, bottom panel 1112 of the first half casing 111 and the second half casing 112 are both provided with communication holes for beverage to pass therethrough.

Preferably, the second half casing 113 is an annular loop and the bottom panel 1112 is another loop so that the integral filtrating member 10 forms a cylinder which is suitable for disposing in the mouth 33 which is constructed in circular shape.

It is worth to mention that the filtrating member can be made of any suitable material such as polyethylene terephthalate, polyvinyl chloride, high density polyethylene and the like.

When the filtrating member 10 is disposed in the mouth 33 of the container body 30, the beverage getting out of the container body 30 through the mouth 33 will be filtrated by the filtration media provided in the filtrating member 10. Accordingly, the filtration media can be carbon, active carbon, charcoal, reverse osmosis, distiller, backwash or other suitable filtration media.

Accordingly, the present invention provide a drinking container for processing beverage housed in a container body 30, wherein the method comprises the following steps.

(i) Couple a filtrating member 10 having a receiving cavity 113 with the container body 30 at a mouth 33, wherein a filtration media is provided in the receiving cavity 113, and guide the beverage in the container body to get out of the container body 30 through the mouth 33, wherein the beverage is filtrated by the filtration media 10.

Preferably, in the step (i), the container body 30 comprises a thread support 34 at the mouth 33, wherein the filtrating member 10 comprises a seat portion 13 outwardly extended from an outer surface of the proximate end thereof, wherein when the filtrating member 10 is put into the container body 30 at the mouth 33, the seat portion 13 of the filtrating member 10 is seated on the thread support 34 of the container body 30.

The method may further comprise a step (ii): Provide a media storing member 20 detachably coupled with the filtrating member 10 for processing the beverage. Preferably, a media contained in the media storing member is thermal treatment solvent.

Preferably, in the step (ii), the filtrating member 10 comprises a body portion 11 has an indent 15 inwardly formed along an inner surface of a proximate end thereof, wherein when the main body 21 of the media storing member 20 is put into the opening 12 of the filtrating member 10, the thread portion 22 of the media storing member 20 is received in the indent 15 of filtrating member 10.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A system for processing beverage housed in a container having a mouth, comprising:
a retaining member detachably engaged with said container at said mouth, and
a media storing member detachably mounted with said retaining member for processing said beverage.

2. The system, as recited in claim 1, wherein said media storing member comprises an elongated main body, wherein said retaining member comprises a body portion defining an opening, wherein said main body of said media storing member is capable of sliding in said opening of said retaining member in such a manner that said media storing member is detachably coupled with said retaining member.

3. The system, as recited in claim 2, wherein said media storing member further comprises a thread portion outwardly extended from an outer surface of an end of said main body, wherein said body portion of said retaining member has an indent inwardly formed along an inner surface of a proximate end thereof, wherein when said main body of said media storing member is disposed into said opening of said retaining member, said thread portion of said media storing member is received in said indent of retaining member.

4. The system, as recited in claim 1, wherein said media storing member is filled with thermal treatment agent.

5. The system, as recited in claim 3, wherein said media storing member is filled with thermal treatment agent.

6. The system, as recited in claim 3, wherein said container comprises a body, wherein said body comprises a thread support at said mouth, wherein said retaining member comprises a seat portion outwardly extended from an outer surface of said proximate end thereof, wherein when said retaining member is disposed into said container at said mouth, said seat portion of said retaining member is seated on said thread support of said container.

7. The system, as recited in claim 5, wherein said container comprises a body, wherein said body comprises a thread support at said mouth, wherein said retaining member comprises a seat portion outwardly extended from an outer surface of said proximate end thereof, wherein when said retaining member is disposed into said container at said mouth, said seat portion of said retaining member is seated on said thread support of said container.

8. The system, as recited in claim 3, wherein said body portion of said retaining member has a plurality of holes for said beverage to pass therethrough, wherein said body portion further has a receiving cavity receiving a filtration media, so that when said retaining member is mounted to said container at said mouth, said beverage getting out of said container from said mouth undergoes a filtration process.

9. The system, as recited in claim 7, wherein said body portion of said retaining member has a plurality of holes for said beverage to pass therethrough, wherein said body portion further has a receiving cavity receiving a filtration media, so that when said retaining member is mounted to said container at said mouth, said beverage getting out of said container from said mouth undergoes a filtration process.

10. The system, as recited in claim 3, wherein said body portion of said retaining member comprises a first half casing and a second half casing defining said receiving cavity, wherein said first half casing extends substantially orthogonally about an axis of said opening and defines said receiving cavity which is also provided substantially orthogonally about said axis of said opening, wherein said second half casing is a sealing member detachably disposed in said receiving cavity to close off said receiving cavity, wherein said filtration media is received in receiving cavity between said first half casing and said second half casing.

11. The system, as recited in claim 9, wherein said body portion of said retaining member comprises a first half casing and a second half casing defining said receiving cavity, wherein said first half casing extends substantially orthogonally about an axis of said opening and defines said receiving cavity which is also provided substantially orthogonally about said axis of said opening, wherein said second half casing is a sealing member detachably disposed in said receiving cavity to close off said receiving cavity, wherein said filtration media is received in receiving cavity between said first half casing and said second half casing.

12. The system, as recited in claim 10, wherein said first half casing comprises a bottom panel extended substantially orthogonally about an axis to define said opening, and an outer wall and an inner wall coaxially extended from an outer edge and an inner edge of said bottom panel respectively, wherein a space between said outer wall and said inner wall forms said receiving cavity for said filtration media to be disposed therein, wherein said second half casing is disposed between said inner wall and said outer wall for closing off said receiving cavity.

13. The system, as recited in claim 11, wherein said first half casing comprises a bottom panel extended substantially orthogonally about an axis to define said opening, and an outer wall and an inner wall coaxially extended from an outer edge and an inner edge of said bottom panel respectively, wherein a space between said outer wall and said inner wall forms said receiving cavity for said filtration media to be disposed therein, wherein said second half casing is disposed between said inner wall and said outer wall for closing off said receiving cavity.

14. The system, as recited in claim 12, wherein said second half casing is an annular loop and said bottom panel is another loop, wherein said integral retaining member forms a cylinder which is capable of being disposed in said mouth which is constructed in circular shape.

15. The system, as recited in claim 13, wherein said second half casing is an annular loop and said bottom panel is another loop, wherein said integral retaining member forms a cylinder which is capable of being disposed in said mouth which is constructed in circular shape.

16. The system, as recited in claim 3, wherein said retaining member is made of suitable material selecting from the group consisting of polyethylene terephthalate, polyvinyl chloride and high density polyethylene.

17. The system, as recited in claim 15, wherein said retaining member is made of suitable material selecting from the group consisting of polyethylene terephthalate, polyvinyl chloride and high density polyethylene.

18. The system, as recited in claim 17, wherein said container comprises a removal lid, wherein said removal lid comprises a lid body and a pull top, wherein said lid body comprises a retainer defining a passage between said lid body and said pull top for beverage to pass therethrough.

19. The system, as recited in claim 18, wherein said media storing member further comprises a protrusion portion extended from said end thereof at said thread portion, wherein said retainer has an end protrudely extend from an inner surface of said lid body, wherein when said media storing member is retained in said container by said retaining member, and said lid is fastened at said mouth of said container, said end of said retainer is biased against protrusion portion to retain said media storing member in position.

20. A method for processing beverage housed in a container having a mouth, wherein said method comprises the following steps:
(a) providing a retaining member at said mouth in such a manner that said retaining member is detachably engaged with said container, wherein said retaining member has an opening ; and
(b) retaining a media storing member in said container at said mouth by said retaining member in such a manner that said media storing member pass through said opening to have contact with said beverage stored in said container.

21. The method, as recited in claim 20, further comprising a step (c): filtrating said beverage when said beverage is guided to pass through a plurality of holes of said retaining member which is installed with a filtration media.

22. The method, as recited in claim 21, wherein said step (a) comprises the following steps:
(a.1) providing a first half casing defining a receiving cavity, wherein said first half casing extends substantially orthogonally about an axis of said opening and defines a receiving cavity which is also provided substantially orthogonally about said axis of said opening; and
(a.2) providing a second half casing detachably disposed in said receiving cavity to close off said receiving cavity, wherein said filtration media is received in said receiving cavity between said first half casing and said second half casing.

23. The method, as recited in claim 22, wherein in said step (a.1), said first half casing comprises a bottom panel extended substantially orthogonally about an axis to define said opening, and an outer wall and an inner wall coaxially extended from an outer edge and an inner edge of said bottom panel respectively, wherein a space between said outer wall and said inner wall forms said receiving cavity for said filtration media to be disposed therein.

24. The method, as recited in claim 23, wherein in said step (b), said media storing member is filled with thermal treatment agent, so that said beverage is heat-exchanging with said thermal treatment agent.

25. The method, as recited in claim 23, wherein in said step (b), said body portion of said retaining member has an indent inwardly formed along an inner surface of a proximate end thereof, wherein when said main body of said media storing member is disposed into said opening of said retaining member, said retaining member retaining said media storing media in position in such a manner that said thread portion of said media storing member is received in said indent of retaining member.

26. A system for processing beverage housed in a container having a mouth, comprising:
a filtration member having a receiving cavity, wherein a filtration media is provided in said receiving cavity, wherein said filtration member is detachably mounted to said container at said mouth in such a manner that said beverage in said container is filtrated by said filtration media when getting out of said container through said mouth.

27. The system, as recited in claim 26, wherein a body of said container comprises a thread support at said mouth, wherein said filtration member comprises a seat portion outwardly extended from an outer surface of said proximate end thereof, wherein when said filtration member is disposed into said container at said mouth, said seat portion of said filtration member is seated on said thread support of said container.

28. The system, as recited in claim 26, further comprising a media storing member detachably coupled with said filtration member for processing said beverage.

29. The system, as recited in claim 27, further comprising a media storing member detachably coupled with said filtration member for processing said beverage.

30-40. (canceled)

41. The system, as recited in claim 28, wherein said media storing member further comprises a thread portion outwardly extended from an outer surface of an end of said main body, wherein said retaining member hand an opening and an indent inwardly formed along an inner surface of a proximate end thereof, wherein when a main body of said media storing member is disposed into said opening of said retaining member, said thread portion of said media storing member is received in said indent of retaining member.

42. The system, as recited in claim 29, wherein said media storing member further comprises a thread portion outwardly extended from an outer surface of an end of said main body, wherein said retaining member hand an opening and an indent inwardly formed along an inner surface of a proximate end thereof, wherein when a main body of said media storing member is disposed into said opening of said retaining member, said thread portion of said media storing member is received in said indent of retaining member.

43. The system, as recited in claim 42, wherein said media storing member is filled with thermal treatment agent.

44. The system, as recited in claim 42, wherein a body portion of said retaining member comprises a first half casing and a second half casing defining said receiving cavity, wherein said first half casing extends substantially orthogonally about an axis of said opening and defines said receiving cavity which is also provided substantially orthogonally about said axis of said opening, wherein said second half casing is a sealing member detachably disposed in said receiving cavity to close off said receiving cavity, wherein said filtration media is received in receiving cavity between said first half casing and said second half casing.

45. The system, as recited in claim 43, wherein a body portion of said retaining member comprises a first half casing and a second half casing defining said receiving cavity, wherein said first half casing extends substantially orthogonally about an axis of said opening and defines said receiving cavity which is also provided substantially orthogonally about said axis of said opening, wherein said second half casing is a sealing member detachably disposed in said receiving cavity to close off said receiving cavity, wherein said filtration media is received in receiving cavity between said first half casing and said second half casing.

46. The system, as recited in claim 45, wherein said first half casing comprises a bottom panel extended substantially orthogonally about an axis to define said opening, and an outer wall and an inner wall coaxially extended from an outer edge and an inner edge of said bottom panel respectively, wherein a space between said outer wall and said inner wall forms said receiving cavity for said filtration media to be disposed therein, wherein said second half casing is disposed between said inner wall and said outer wall for closing off said receiving cavity.

47. A method for processing beverage housed in a container having a mouth, wherein the method comprises the following steps:
(i) Coupling a filtration member having a receiving cavity with said container at said mouth, wherein a filtration media is provided in said receiving cavity, and guiding said beverage in said container to get out of said container through said mouth, wherein said beverage is filtrated by said filtration media.

48. The method, as recited in claim 47, wherein further comprising a step (ii): providing a media storing member detachably coupled with said filtration member for processing said beverage.

49. The method, as recited in claim 47, wherein in said step (i), a body of said container comprises a thread support at said mouth, wherein said filtration member comprises a seat portion outwardly extended from an outer surface of said proximate end thereof, wherein when said filtration member is put into said container at said mouth, wherein said seat portion of said filtration member is seated on said thread support of said container.

50. The method, as recited in claim 48, wherein in said step (i), a body of said container comprises a thread support at said mouth, wherein said filtration member comprises a seat portion outwardly extended from an outer surface of said proximate end thereof, wherein when said filtration member is put into said container at said mouth, wherein said seat portion of said filtration member is seated on said thread support of said container.

51. The method, as recited in claim 50, wherein said media storing member is filled with thermal treatment agent.

52. The method, as recited in claim 50, wherein in said step (ii), said filtration member has an opening and an indent inwardly formed along an inner surface of a proximate end thereof, wherein when said main body of said media storing member is disposed into said opening of said filtration member, said thread portion of said media storing member is received in said indent of filtration member.
